(19) United States
(12) Patent Application Publication
(10) Pub. No.: US 2007/0251059 A1
(43) Pub. Date: Nov. 1, 2007

(54) Umbrella handle

(76) Inventor: Ching-Chuan You, Taipei (TW)

Correspondence Address: CHING-CHUAN YOU, Rm. 532, 5FL. No. 144, Ming Chuan E. Rd., Sec. 3, P.O. Box 1-79, Taipei, 105, TW

(21) Appl. No.: 11/819,772

(22) Filed: Jun. 29, 2007

Related U.S. Application Data
(63) Continuation-in-part of application No. 11/203,167, filed on Aug. 15, 2005.

(51) Int. Cl. B25G 1/10

(52) U.S. Cl. 16/430

(57) ABSTRACT

Provided is an umbrella handle comprising a tube, a hollow upper enlargement secured to one end of the tube and being in communication with a bore of the tube, a lower enlargement secured to and concealed the other end of the tube, and a flexible gripping member shaped to be easily gripped by hand and formed around the tube and between the upper and the lower enlargements such that a shank is adapted to have its lower portion inserted through the upper enlargement into the bore of the tube to engage the lower enlargement and secure thereto. The invention has advantages of increased gripping comfort, mass production, and low manufacturing cost.

This is a continuation-in-part of U.S. patent application Ser. No. 11/203,167, filed on Aug. 15, 2005 in the name of You, Ching-Chuan and entitled “UMBRELLA HANDLE” is now pending.

### BACKGROUND OF THE INVENTION

1. Field of Invention

The present invention generally relates to umbrella components and more particularly to an umbrella handle with improved characteristics having advantages of increased gripping comfort, mass production, and low manufacturing cost.

2. Description of Related Art

One type of conventional umbrella handle is formed of thermoplastic for the sake of lowering manufacturing cost. However, its gripping comfort is poor.

Another type of conventional umbrella handle is formed of wood for the sake of increasing value and gripping comfort. However, its manufacturing cost is very high because many complicated manufacturing processes including cutting, polishing, forming, and painting are involved. Also, the cost of wood is increasing gradually due to environmental protection concern. Still another type of conventional umbrella handle is formed by gluing wood chips and molding. However, it has the drawback of poor gripping comfort similar to one formed of thermoplastic.

A further type of conventional umbrella handle 1 is formed by performing the following steps as illustrated in FIGS. 1A to 1D. A short tube 11 formed of thermoplastic is provided. An upper enlargement 12 is secured to one end of the tube 11 by gluing. A short outer tube 13 of nonrigid material is formed on the upper enlargement 12 and around the tube 11 so as to define an annular space therebetween. A gelatinous substance 14 is filled in the space. Finally, a lower enlargement 15 is secured to the other ends of the tubes 11 and 13 to conceal the gelatinous substance 14 by gluing. A user may feel a degree of comfort while gripping the flexible handle 1.

However, the further type of prior umbrella handle 1 has one drawback. In detail, cracks may occur after a period time of use due to poor gluing or other reasons, such as, gluing contacting relationship in among of the tube 11, the lower enlargement 15, the upper enlargement 12 and the short outer tube 13 will be varied due to different materials having been encountered to expand when hot and to shrink when cold. Thus, the gelatinous substance 14 may leak from the cracks. A user may feel uncomfortable by touching the leaked gelatinous substance 14 while gripping the handle 1. Further, washing the gelatinous substance 14 stuck on the hand or a personal article (e.g., clothes, bags or the like) is not easy. Thus, the need for improvement still exists.

### SUMMARY OF THE INVENTION

It is therefore an object of the present invention to provide an umbrella handle having advantages of increased gripping comfort, mass production, and low manufacturing cost.

To achieve the above and other objects, the present invention provides a handle of an umbrella comprising a first tube having an upper end and a lower end;

a second tube having an upper end and a lower end, the second tube disposed on an outer circumferential surface of the first tube and being intimately interconnected together with the first tube;

a hollow upper enlargement having an upper surface, a lower surface, and an opening, the opening secured to both the upper ends of the first tube and the second tube, and the opening of the upper enlargement being in communication with a bore of the first tube;

a lower enlargement having an upper surface, a lower surface, and a well formed on the upper surface of the lower enlargement, the well being secured to both the lower ends of the first tube and the second tube, both ends of which are concealed by the lower enlargement; and

a flexible gripping member shaped to be easily gripped by hand and formed by injection molding with fairly elastic thermoplastic material around an outer surface of the second tube and between the lower surface of the upper enlargement and the upper surface of the lower enlargement to form a flexible gripping member having a smooth circumferential surface together with circumferential surfaces of the upper and the lower enlargements such that a shank of an umbrella is adapted to have a lower portion thereof inserted through the opening of the upper enlargement into the bore of the first tube to engage the well of the lower enlargement and secure thereto;

wherein the gripping member further comprises a smooth projection formed on the circumferential surface thereof and the circumferential surface of the gripping member is divided into an upper portion and a lower portion.

The above and other objects, features and advantages of the present invention will become apparent from the following detailed description taken with the accompanying drawings.

### BRIEF DESCRIPTION OF THE DRAWINGS

FIGS. 1A to 1D are sectional views illustrating steps of manufacturing a conventional umbrella handle;

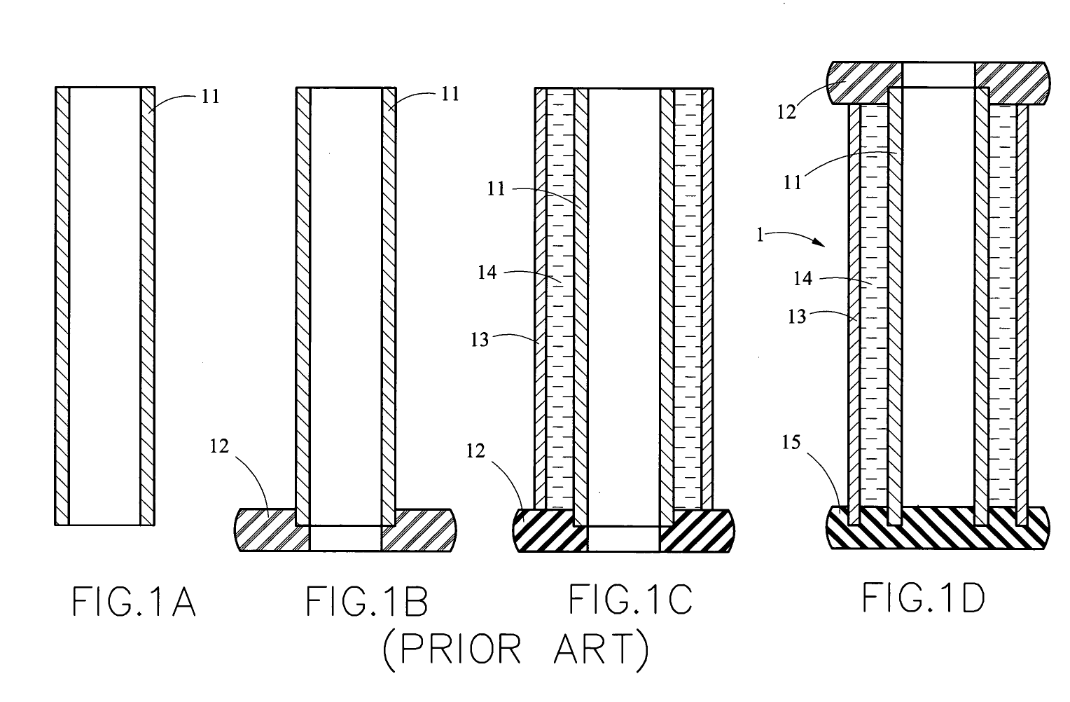

FIGS. 2A to 2C are sectional views illustrating steps of manufacturing a first preferred embodiment of umbrella handle according to the invention;

FIGS. 3A to 3C are sectional views illustrating steps of manufacturing a second preferred embodiment of umbrella handle according to the invention;

FIGS. 4A to 4D are sectional views illustrating steps of manufacturing a third preferred embodiment of umbrella handle according to the invention; and

FIG. 5 is a plane view of an umbrella handle constructed in accordance with either preferred embodiment of the invention.

### DETAILED DESCRIPTION OF THE INVENTION

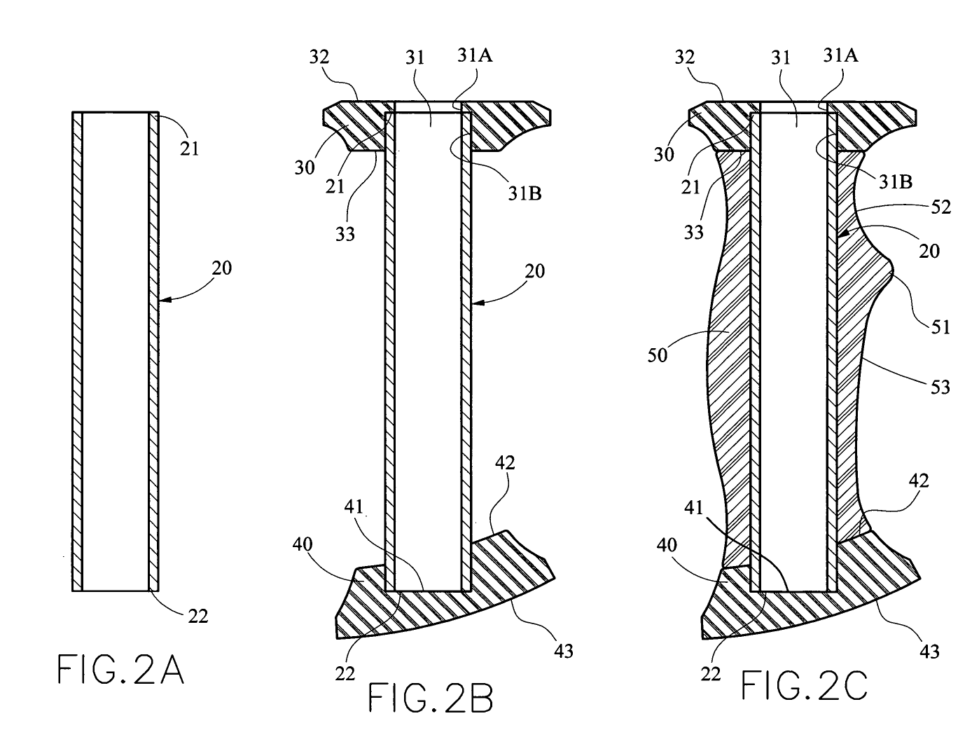

Referring to FIGS. 2A to 2C, a process of manufacturing an umbrella handle in accordance with a first preferred embodiment of the invention is illustrated. First, a first inner tube 20 of thermoplastic is formed by injection molding. The first tube 20 may be formed of a hard material such as metal or fiberglass in other embodiments. A hollow upper enlargement 30 has an upper small opening 31A formed on an upper flat surface 32 and a lower large opening 31B extending from a lower flat surface 33 to a most middle portion of the upper enlargement 30, and the large opening 31B is secured to an upper end 21 of the tube 20 by for example gluing or heating or molding and a through hole 31 of the upper enlargement 30 is in communication with the bore of the tube 20. The circumferential portion of the upper enlargement 30 is formed with an arc-shaped surface in order to have a smooth surface connection with an outer surface of the hereinafter mentioned gripping member 50. A lower enlargement 40 having an upper arc-shaped surface 42, a lower arc-shaped surface 43, and a well 41 formed on the upper arc-shaped surface 42 of the lower enlargement 40, the well 41 is secured to the lower end 22 of the tube 2—by for example gluing or heating or molding. The lower end 22 of the tube 20 is concealed by the lower enlargement 40. The circumferential portion of the lower enlargement 40 is also formed with an arc-shaped surface in order to have a smooth surface connection with an outer surface of the hereinafter mentioned gripping member 50 (see FIG. 2C).

Thus, a gripping member 50 is formed around the tube 20. Finally, a fairly elastic thermoplastic (e.g., silicon rubber) is molded around the gripping member 50 between the circumferential portion of the upper enlargement 3 and the lower surface 33 of the upper enlargement 30 and the upper arc-shaped surface 42 and the circumferential portion of the lower enlargement 40 to form a flexible gripping member 50 having a smooth circumferential surface together with the circumferential surfaces of the upper and the lower enlargements 30 and 40 and which preferably, is shaped to be easily gripped by hand. Moreover, a smooth projection 51 is formed on the gripping member 50. The provision of the projection 51 can increase comfort of gripping the handle by hand (i.e., an ergonomic design).

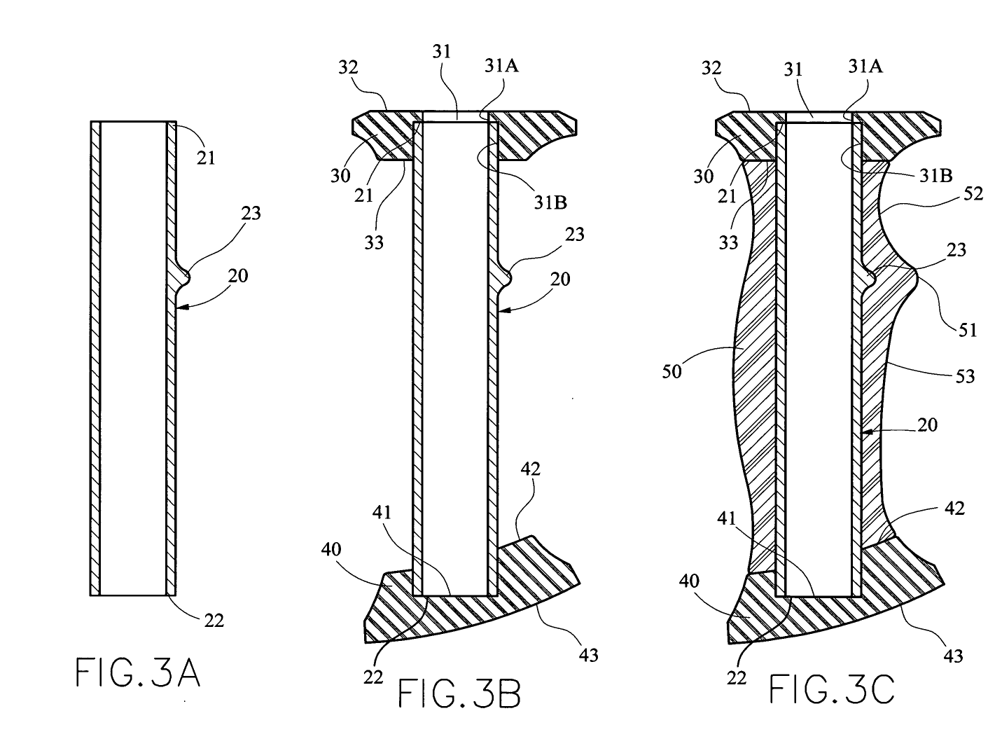

Referring to FIGS. 3A to 3C, an umbrella handle constructed in accordance with a second preferred embodiment of the invention is shown. The second embodiment is identical to the first embodiment, except that a protrusion 23 is formed on an outer surface of the first tube 20 and is disposed corresponding to the projection 51. The protrusion 23 is provided to prevent the gripping member 50 from being rotated with respect to the outer surface of the tube 20 during a long time period of use.

As the gravity of the umbrella is downward, it will cause an uncomfortable feeling for gripping handle of the user. In this way, a smooth projection 51 forming on the gripping member 50 and dividing the circumferential surface of the gripping member 50 into an upper portion 52 and a lower portion 53. In order to be divergent the downward gravity of the umbrella in two sections on the upper portion 52 held by thumb and index-finger and the lower portion 53 held by middle, ring, and little fingers, thus, the provision of the smooth projection 51 can increase comfort of gripping the handle by fingers.

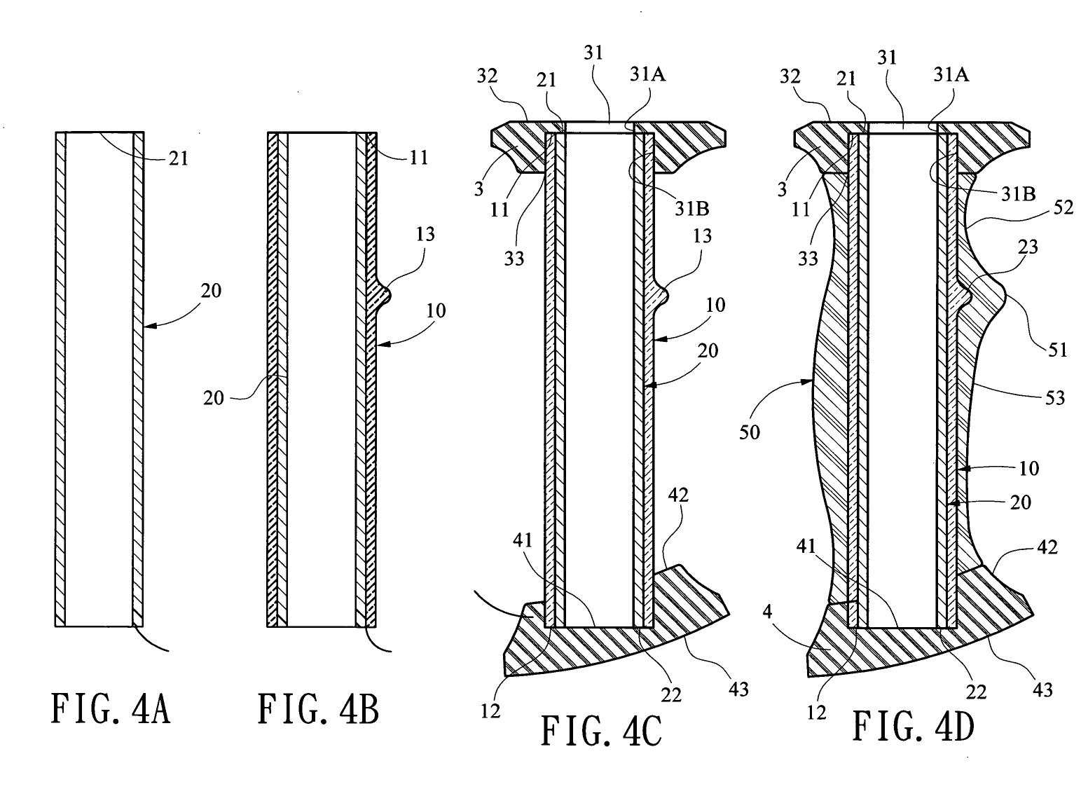

Referring to FIGS. 4A to 4D, an umbrella handle constructed in accordance with a third preferred embodiment of the invention is shown. The third embodiment is identical to the second embodiment, except that the second tube 10 is disposed between the first tube 20 and the gripping member 50 to serve as a bridge member for both of the first tube 20 and the gripping member 50 and the first tube 20 has no protrusion 23 but a protrusion 13 is formed on an outer surface of the second tube 10 and is disposed corresponding to the smooth projection 51 of the gripping member 50. The protrusion 13 provided on the outer surface of the second tube 10 can prevent the gripping member 50 from being rotated with respect to the outer surface of the second tube 10 during a long time period of use. The most important feature of this embodiment is that the second tube 10 is a significant connection bridge member for both the first tube 20 and the gripping member 50, as the first tube 20 is a preferably hard tube (e.g., polypropylene), and the gripping member 50 is a fairly elastic thermoplastic material (e.g., silicon rubber), the intimate interconnection relationship between the outer surface of the second tube 20 and the inner surface of the gripping member 50 will be sometime varied due to different circumstances condition. In order to upgrade the quality of the umbrella handle of the invention, providing material hardness of second tube 10 between the first tube 20 and the gripping member 50 is preferable. The preferred material of second tube 10 is of rubber which is selected from the same group of silicon rubber of thermoplastic commercially available. Thus, the second tube 10 may play an important role for the umbrella handle of the invention during a long time period of use in different ambient environmental condition.

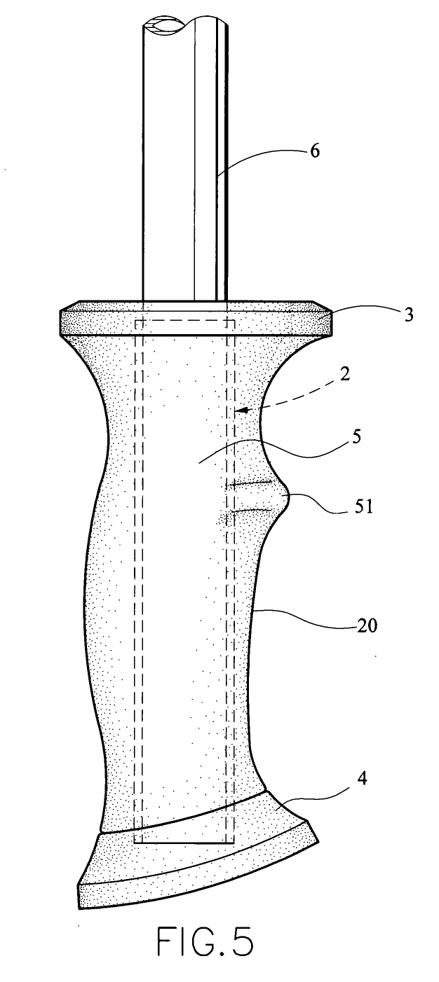

Referring to FIG. 5, an umbrella handle constructed in accordance with either preferred embodiment of the invention is shown. A shank 6 has its lower portion snugly inserted through the hole 31 of the upper enlargement 30 into the bore of the tube 20 to engage the lower enlargement 40 and is secured thereto by for example gluing or heating or molding.

A flexible gripping member shaped to be easily gripped by hand and formed by injection molding with thermoplastic material or silicon rubber material around an outer surface of the first or the second tube and between the lower surface of the upper enlargements and the upper surface of the lower enlargements to firmly combine the upper enlargement, the tube, and the lower enlargement together and to form a flexible gripping member having a smooth circumferential surface together with the circumferential surfaces of the upper and the lower enlargements wherein the gripping member further comprises a smooth-point shaped projection 51 formed on the circumferential surface thereof and dividing the circumferential surface of the gripping portion into an upper portion 52 and a lower portion 53, and wherein the tube further comprises a protrusion 13 or 23 formed on the outer surface thereof, and a position of the protrusion is disposed corresponding to that of the projection 51.

The umbrella handle thus has the following advantages including increased gripping comfort, mass production, and low manufacturing cost.

While the invention herein disclosed has been described by means of specific embodiments, numerous modifications and variations could be made thereto by those skilled in the art without departing from the scope and spirit of the invention set forth in the claims.

What is claimed is:

1. A handle of an umbrella comprising:
a tube having an upper end and a lower end;
a hollow upper enlargement having an upper small opening formed on an upper surface and a lower large opening extending from a lower surface to a most middle portion of the upper enlargement, the large opening secured to the upper end of the tube and the upper opening of the upper enlargement being in communication with a bore of the tube;
a lower enlargement having an upper surface, a lower surface, and a well formed on the upper surface of the lower enlargement, the well being secured to the lower end of the tube, which is concealed by the lower enlargement; and
a flexible gripping member shaped to be easily gripped by hand and formed by injection molding with fairly elastic thermoplastic around an outer surface of the tube and between the lower surface of the upper enlargements and the upper surface of the lower enlargements to form a flexible gripping member having a smooth circumferential surface together with the circumferential surfaces of the upper and the lower enlargements such that a shank is adapted to have a lower portion thereof inserted through the opening of the upper enlargement into the bore of the tube to engage the well of the lower enlargement and secure thereto;
wherein the gripping member further comprises a smooth projection formed on the circumferential surface thereof and the circumferential surface of the gripping member is divided into an upper portion and a lower portion.

2. The handle of claim 1, wherein the tube further comprises a protrusion formed on the circumferential surface thereof, and a position of the protrusion is disposed corresponding to that of the projection.

3. The handle of claim 1, wherein the tube is of a hard tube and the thermoplastic material of gripping member is of silicon rubber.

4. The handle of claim 3, wherein the hard tube is formed of thermoplastic.

5. The handle of claim 4, wherein the thermoplastic is of polypropylene.

6. A handle of an umbrella comprising:
a first tube having an upper end and a lower end;
a second tube having an upper end and a lower end, the second tube disposed on an outer circumferential surface of the first tube and being intimately interconnected together with the first tube;
a hollow upper enlargement having an upper surface, a lower surface, and an opening, the opening secured to both the upper ends of the first tube and the second tube, and the opening of the upper enlargement being in communication with a bore of the first tube;
a lower enlargement having an upper surface, a lower surface, and a well formed on the upper surface of the lower enlargement, the well being secured to both the lower ends of the first tube and the second tube, both ends of which are concealed by the lower enlargement; and
a flexible gripping member shaped to be easily gripped by hand and formed by injection molding with fairly elastic thermoplastic material around an outer surface of the second tube and between the lower surface of the upper enlargement and the upper surface of the lower enlargement to form a flexible gripping member having a smooth circumferential surface together with circumferential surfaces of the upper and the lower enlargements such that a shank of an umbrella is adapted to have a lower portion thereof inserted through the opening of the upper enlargement into the bore of the first tube to engage the well of the lower enlargement and secure thereto;
wherein the gripping member further comprises a smooth projection formed on the circumferential surface thereof and the circumferential surface of the gripping member is divided into an upper portion and a lower portion.

7. The handle of claim 6, wherein the second tube further comprises a protrusion formed on the circumferential surface thereof, and a position of the protrusion is disposed corresponding to that of the projection.

8. The handle of claim 6, wherein the first tube is of a hard tube of thermoplastic, the thermoplastic material of gripping member is of silicon rubber, and the second tube is formed of rubber selected from a same group of silicon rubber.

9. The handle of claim 8, wherein the thermoplastic is of polypropylene.

10. The handle of claim 8, wherein a hardness of rubber is between that of the first tube and the gripping member.
